(19) United States
(12) Patent Application Publication
(10) Pub. No.: US 2025/0014424 A1
(43) Pub. Date: Jan. 9, 2025

(54) Brand E-sports Platform for Consoles

(71) Applicant: Milind S. Bharvirkar, Orlando, FL (US)

(72) Inventor: Milind S. Bharvirkar, Orlando, FL (US)

(21) Appl. No.: 18/219,674

(22) Filed: Jul. 8, 2023

(51) Int. Cl. G07F 17/32; G06Q 20/38

(52) U.S. Cl. CPC G07F 17/3255; G06Q 20/389; G07F 17/323; G07F 17/3241

(57) ABSTRACT

A brand e-sports platform with mobile application (herein referred to as GO4) for gaming consoles is disclosed. The GO4 incentivizes customer awareness and enhances merchant visibility by allowing commercial brands to organize sponsored e-sports tournaments within gaming consoles, such as Xbox and PlayStation etc. Using the GO4 mobile app, players receive a schedule of sponsored tournaments. The mobile app allows the player to register for the tournament. The player receives a code to enter a sponsor's tournament on their console. After the tournament is over, scores are uploaded to the player's mobile app to see if they are eligible to receive prizes, special offers, or loyalty points from the sponsor. The mobile app allows the player to purchase their offers and redeem their loyalty points for prizes. An object of GO4 is to create measurable brand engagement within the console gaming community.

### CROSS-REFERENCE TO RELATED APPLICATIONS

The present application includes subject matter disclosed in and claims priority to a provisional application entitled “Brand E-sports Platform for Consoles” filed Jan. 11, 2023 and assigned Ser. No. 63/438,380 describing an invention made by the present inventor.

### FIELD OF THE INVENTION

The present invention relates to gaming consoles. More specifically it relates to a brand e-sports platform with mobile application for gaming consoles.

### BACKGROUND

The first video game consoles were first established in the early 1970s. Ralph H. Baer devised the concept of playing a simple, spot-based tennis game on a television screen in 1966, which later became the basis of the Magnavox Odyssey in 1972. Several years later, Atari, Inc. developed the first successful arcade game called Pong that developed into a home version. The first consoles were capable of playing only a very limited number of games built into the hardware. Programmable consoles using swappable ROM cartridges were introduced with the Atari 2600, released in 1977. Handheld consoles emerged from technology improvements in handheld electronic games as these shifted from mechanical to electronic/digital logic, and away from light-emitting diode (LED) indicators to liquid-crystal displays (LCD) that resembled video screens more closely. Early examples include the Microvision and Game & Watch in 1980, and this concept became the Game Boy in 1989. Both home and handheld consoles have become more advanced following global changes in technology. These technological shifts include improved electronic and computer chip manufacturing to increase computational power at lower costs and size, the introduction of 3D graphics and hardware-based graphic processors for real-time rendering, digital communications such as the Internet, wireless networking and Bluetooth, and larger and denser media formats as well as digital distribution. Throughout the 1990s and early 2000s gaming consoles became increasingly more powerful and leveraged the internet to allow for massive, multiplayer gaming. While in-game advertising on console has been available for some time, it does not accurately measure return on investment. The console platform is not ideal for distributing brand offers or purchasing products. Currently, restaurant chains have created their own mobile game apps, yet most of these apps have not been successful, primarily because restaurants do not make fun or engaging games. GO4 can connect a mobile app and traditional console games in an effective way to give advertisers a performance base marketing platform. The GO4 platform can only charge advertisers when players decide to play for their promotion or esports tournament, thereby creating voluntary engagement. Sponsors can forward product offers to participates GO4 mobile app. Players can now enjoy free tournament competitions and promotions, and ‘buy-ins’ can be paid by the advertiser.

### SUMMARY OF THE INVENTION

The device herein disclosed and described provides a solution to the shortcomings in the prior art through the disclosure of a brand e-sports platform with mobile application for gaming consoles. An object of the invention is to drive traffic to online and retail businesses. When these console games are linked to the GO4 platform, merchants can drive a schedule of prize promotions and tournaments to player's mobile apps. Players can register on their mobile and receive a code. They can enter the code to enter the competition on the console game. Once the game is over, offer incentive and rewards can be delivered to the player's app. Branded game apps are common. Typically, food retailers use game apps to deliver offers to consumers such as “Play Burger King game app and win a BOGO whopper.” An object of the current system is to allow a console game to deliver a similar experience. An advertiser can create a prize promotion on a console and delivers offers to participates on their mobile app. The mobile app can make it easy for consumers to sign up and receive offers, prizes, points, as well as monitor leaderboard standings. The mobile app also can make it easier for consumers to use their rewards as players cannot carry their consoles into retail stores to redeem prizes. Yet, the mobile app can be a carrier for the prizes, offers, and loyalty points that can be redeemed in the retail location using a smart phone etc.

Another object of the invention is an advertiser can choose a budget to spend. The advertiser can be charged a pay per engagement when a player enters their promotion. Once a certain amount of players participate, the tournament can end. Conversely, if no one enters the tournament, the advertiser can not be charged for running the promotion.

Another object of the invention is a web portal or app to create virtual tournaments in gaming consoles using a mobile app to reach potential customers. Business owners can setup a competition, furnish reward tokens and offer discounts to console gamers. For example, an online clothing store uses the app to connect with multiple console gamers and offers players access to a competitive game. Those who score the highest on the game can receive digital tokens that are redeemable at the online clothing store and offers can even be purchased using the system app.

Another object of the invention is to provide a means to advertise during tournaments to generate brand and sponsors consumer awareness. For example, in the scenario mentioned above users can allow their tournament (along with their brand logo) to be showcased across multiple game consoles.

Another object of the invention is to provide a means to remote monitoring of multiple game events for revenue, promotion results, and maintenance. The app can allow advertisers to connect and network to multiple consoles, monitor any tournaments, and maintain any issues that arise during said tournaments.

Another object of the invention is to offer gameplay reward options. For example, one merchant can offer digital discount coupons, another vendor can offer digital tokens and other merchants can offer popular block chain tokens. This strategy can incentivize all types of players to participate and frequent participating stores.

Another object of the invention is to collect data and performs trend analysis using artificial intelligence (AI). The app can collect data over time and matches specific promotions to consumers.

This type of Al can inform vendors to make more lucrative choices when organizing events. For example, the Al learns that males play PUBG more than females. When an online men's clothing store develops a tournament for game consoles, the Al can recommend connecting with PUBG games to allow the vendor to reach their target audience.

Another object of the invention is to target players with promotional messages. After gamers participate in a tournament, the app can send gamers advertisements in the form of emails and text messages regarding tournament results and upcoming events.

Another object of the invention is the mobile app allows the player to purchase an offer in the mobile app, similar to Amazon. The platform can have payment rails to pay the merchants or brands their share of the revenue.

Upon a reading this disclosure, those ordinarily skilled in the art will recognize various means for carrying out these intended features of the invention. As such, it is to be understood that other methods, applications and systems adapted to the task may be configured to carry out these features and are therefore considered to be within the scope and intent of the present invention, and are anticipated.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those ordinarily skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the GO4.

FIG. 2 shows a representative view of the GO4's method.

FIG. 3 shows an example of optional block chain features.

FIG. 4 shows the GO4 method.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

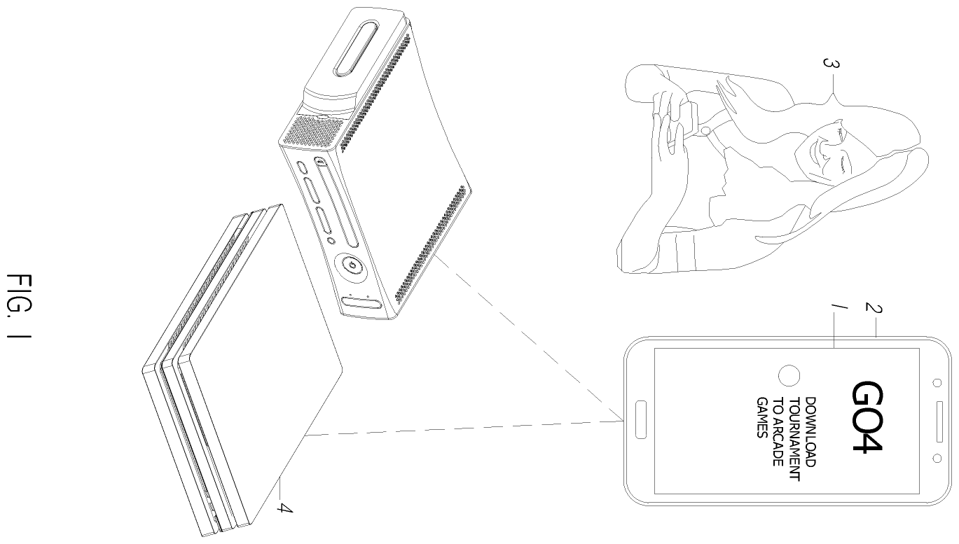

FIG. 1 shows a preferred embodiment of the GO4 comprised of a software app 1 operating system on a smartphone 2 being operated by user 3 and networking with a plurality of console games.

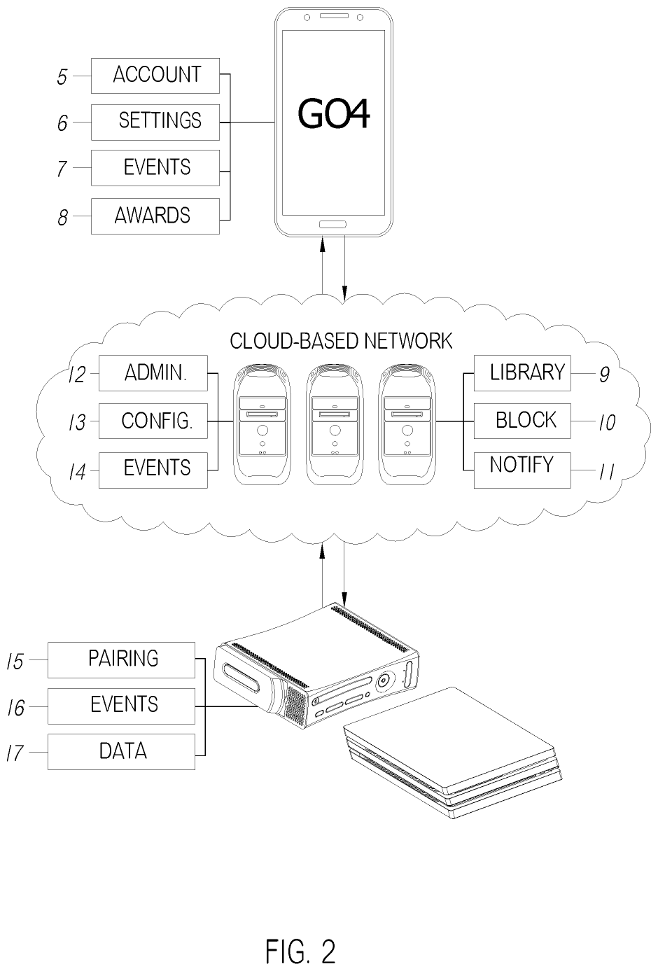

FIG. 2 shows a representative view of the invention's method wherein app 1 having operations that include but are not limited to: account information 5 (subscriptions, demographics, payments etc.); settings 6 (selecting console games etc.); creating events 7 (tournaments, schedules, promotions etc.); and issuing rewards 8 (tokens, discounts etc.) being operated on a mobile device that includes but is not limited to a smart phone, tablet, laptop etc. The game consoles having operations such as but not limited to: pairing console with app 15 (local and/or wide area networks, Wi-Fi, etc.); event activities 16 (high scores, record keeping etc.); and data transmission 17 (winners, statistics, maintenance etc.). The user's mobile device and gaming consoles being connected by means of cloud-based network having routines that include but are not limited to: administrative functions 12 (user data, financials, etc.); arcade machine configurations 13 (parings, machine type, etc.); event setups 14 (tournament logistics, calendars, participant lists etc.); library files 9 (encrypted event records etc.); optional block chain operations 10 (tokens, wallets, hashing etc.) and notifications 11 (email, SMS, text messages etc.).

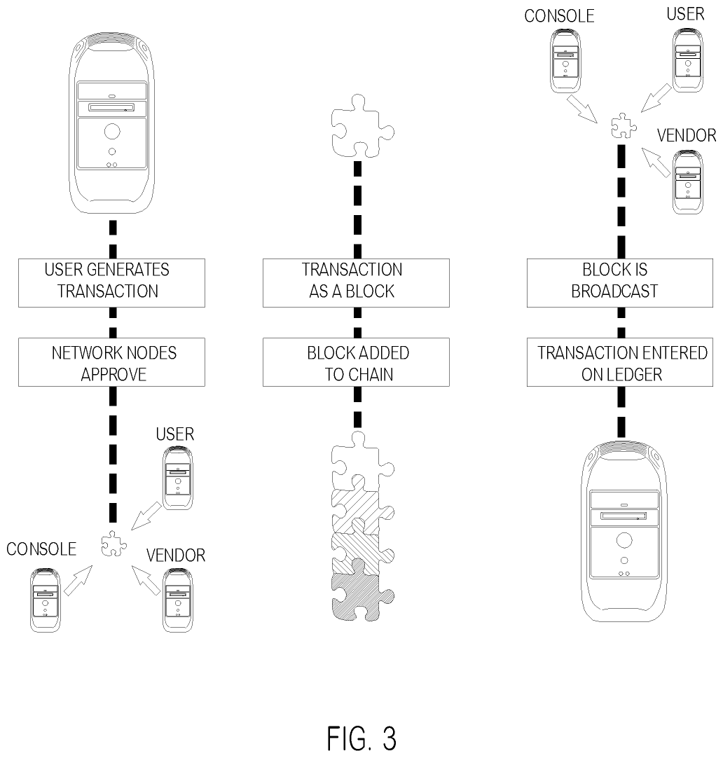

FIG. 3 shows an optional embodiment of the app having block chain software recognizes the initial transaction and it is registered as a genesis block after being approved by network nodes made up of but not limited to: vendors, consoles, and gamers etc. When a gamer participates in a tournament, each score is tabulated as a transaction being is encrypted and added to the previous block forming a hashed block chain wherein each transaction has a timestamp and metadata that is broadcast to said authorized stakeholders as a recorded transaction and being available only on the cloud network. By design, a block chain is resistant to modification of the data. For use as a distributed ledger, the block chain is typically managed by a peer-to-peer network, collectively adhering to a protocol for inter-node communication and validating new blocks. Once recorded, the data in any given block cannot be altered retroactively, without alteration of all subsequent blocks, which requires consensus of the network majority. Combined with smart contracts, such block chains can be considered as a decentralized notary service that allows for transparency so that anyone with preset privileges can see what is inside a data element record constructed using cryptographic hash and time stamped. Smart contracts are dynamic, live contracts that once created cannot be changed but can perform certain actions when certain conditions are met—such as sharing records automatically with pre-approved parties using digital signatures. FIG. 3 showing the optional blockchain embodiment with the notification process as gamers instructors, vendors and consoles are notified of said scores posted on the cloud interface on smart phones and desktop computers etc. FIG. 4 shows the steps of the GO4's method.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A brand e-sports platform with a mobile application (GO4) for gaming consoles, comprising:
a) A mobile app that allows players to receive a schedule of sponsored tournaments, register for tournaments, and enter a sponsor's tournament on their gaming console using a unique code.
b) A system for uploading tournament scores to the player's mobile app, determining eligibility for prizes, special offers, or loyalty points from sponsors, and allowing players to purchase offers and redeem loyalty points for prizes.
c) A performance-based marketing platform that charges advertisers when players decide to play for their promotion or esports tournament, creating voluntary engagement.
d) A web portal or app for creating virtual tournaments in gaming consoles, allowing business owners to set up competitions, furnish reward tokens, and offer discounts to console gamers.
e) Advertisements displayed during tournaments to generate brand and consumer awareness.
f) Remote monitoring of multiple game events for revenue, promotion results, and maintenance.
g) Gameplay reward options, including digital discount coupons, digital tokens, and popular blockchain tokens to incentivize player participation.
h) Data collection and trend analysis using artificial intelligence (AI) to inform vendors about more lucrative choices when organizing events.
i) Targeted promotional messages sent to players via email and text messages regarding tournament results and upcoming events.
j) A mobile app that allows players to purchase offers within the app, with payment rails to pay merchants or brands their share of the revenue.

2. The brand e-sports platform of claim 1, wherein the mobile app operates on a smartphone, tablet, or laptop.

3. The brand e-sports platform of claim 1, wherein the gaming consoles include Xbox and PlayStation.

4. The brand e-sports platform of claim 1, further comprising optional block chain features for recording and encrypting tournament transactions, allowing for transparency and secure storage of data.

5. The brand e-sports platform of claim 1, wherein the mobile app provides notifications to gamers, vendors, and consoles regarding tournament scores and updates.

6. A method for operating a brand e-sports platform with a mobile application (GO4) for gaming consoles, comprising:
a. Providing a mobile app that allows players to receive tournament schedules, register for tournaments, and enter sponsor's tournaments on gaming consoles.
b. Uploading tournament scores to the mobile app, determining eligibility for prizes, special offers, or loyalty points, and enabling players to purchase offers and redeem loyalty points for prizes.
c. Charging advertisers based on player engagement in promotions or esports tournaments.
d. Creating virtual tournaments in gaming consoles using a web portal or app, allowing business owners to set up competitions, furnish reward tokens, and offer discounts.
e. Displaying advertisements during tournaments to generate brand and consumer awareness.
f. Remotely monitoring multiple game events for revenue, promotion results, and maintenance.
g. Providing gameplay reward options, including digital discount coupons, digital tokens, and popular blockchain tokens.
h. Collecting data and performing trend analysis using artificial intelligence (AI) to inform vendors about more lucrative choices when organizing events.
i. Targeting players with promotional messages via email and text messages.
j. Enabling players to purchase offers within the mobile app, with payment rails to pay merchants or brands their share of the revenue.

7. The method of claim 6, wherein the mobile app operates on a smartphone, tablet, or laptop.

8. The method of claim 6, wherein the gaming consoles include Xbox and PlayStation.

9. The method of claim 6, further comprising recording and encrypting tournament transactions using optional block chain features for transparency and secure storage of data.

10. The method of claim 6, further comprising providing notifications to gamers, vendors, and consoles regarding tournament scores and updates.
